(19) United States
(12) Patent Application Publication
(10) Pub. No.: US 2016/0190899 A1
(43) Pub. Date: Jun. 30, 2016

(54) ELECTRIC COMPRESSOR

(71) Applicant: Calsonic Kansei Corporation, Saitama-shi, Saitama (JP)

(72) Inventors: Junichirou TERAZAWA, Saitama-shi, Saitama (JP); Toshiharu WATANABE, Saitama-shi, Saitama (JP); Katsuyoshi KAWACHI, Saitama-shi, Saitama (JP); Mitsuji YAMAMOTO, Saitama-shi, Saitama (JP)

(73) Assignee: CALSONIC KANSEI CORPORATION, Saitama-shi, Saitama (JP)

(21) Appl. No.: 14/648,986

(22) PCT Filed: Oct. 15, 2013
(86) PCT No.: PCT/JP2013/077982

§ 371 Date: Jun. 2, 2015

(30) Foreign Application Priority Data
Dec. 4, 2012 (JP) 2012-265034

(51) Int. Cl. H02K 11/00; F04C 29/00; F04C 18/344

(52) U.S. Cl. CPC H02K 11/0094; F04C 18/344; F04C 29/0085

(57) ABSTRACT

An electric compressor includes a hollow cylindrical housing, a compression unit that compresses refrigerant, a motor that functions as a drive source of the compression unit, an inverter that controls the motor, and a refrigerant liquid accumulation unit that accumulates refrigerant liquid in the housing. The refrigerant liquid accumulation unit is disposed at a lower portion in the housing when the electric compressor is installed on the vehicle. According to the electric compressor, the refrigerant liquid is accumulated in the refrigerant liquid accumulation portion at a long-time stop, so that degradation of insulation property in the electric compressor (especially, of the motor and the inverter) can be prevented.

### TECHNICAL FIELD

The present invention relates to an electric compressor, especially relates to an electric compressor integrated with an inverter.

### BACKGROUND ART

As shown in a Patent Document 1 listed below, a general electric compressor includes an electric motor that is housed in a motor casing, an inverter that has a circuit board for controlling the electric motor, and a compression unit that compresses refrigerant.

The refrigerant suctioned from a suction port formed on a circumferential wall of the motor casing is compressed by the compression unit, and then discharged from a discharge port formed on the circumferential wall of the motor casing to a refrigeration cycle.

### PRIOR ART DOCUMENT

### Patent Documents

Patent Document 1: Japanese Patent Application Publication No. 2007-198341

### SUMMARY OF INVENTION

However, if the electric compressor is stopped for a long time when outside temperature is low as in winter, it is concerned that refrigerant flows from the refrigeration cycle to the electric motor may liquidized.

In addition, if the liquidized refrigerant (hereinafter, referred as refrigerant liquid) stays in the electric compressor, the refrigerant liquid gets in touch with a neutral point of the electric motor, a hermetic terminal that electrically connects the electric motor with the inverter or the like, so that insulation resistance of the neutral point, the hermetic terminal or the like degrades.

An object of the present invention is to provide an electric compressor that can keep its internal insulation property.

An aspect of the present invention provides an electric compressor to be installed on a vehicle, the compressor comprising: a hollow cylindrical housing; a compression unit that is provided in the housing, and compresses refrigerant; a motor that provided in the housing, and functions as a drive source of the compression unit; an inverter that provided in the housing, and controls the motor; and a refrigerant liquid accumulation unit that is provided in the housing, and accumulates refrigerant liquid in the housing, wherein the refrigerant liquid accumulation unit is disposed at a lower portion in the housing when the electric compressor is installed on the vehicle.

According to the aspect, the refrigerant liquid flows down due to gravitational attraction, and then accumulated in the refrigerant liquid accumulation portion. Therefore, degradation of insulation property in the electric compressor (especially, of the motor and the inverter) caused by the refrigerant liquid can be prevented.

Here, it is preferable that the motor has a stator around which coils are wound and a motor rotor, a neutral point of the coils is connected with the inverter via a hermetic terminal, and the refrigerant liquid accumulation portion is arranged at a lower position than the hermetic terminal and the neutral point when the electric compressor is installed on the vehicle.

According to this, since the refrigerant liquid is accumulated in the refrigerant liquid accumulation portion located lower than the hermetic terminal and the neutral point, the hermetic terminal and the neutral point can be prevented from being submerged in the refrigerant liquid. Therefore, the insulation property in the electric compressor can be kept.

In addition, it is preferable that the refrigerant liquid accumulation portion is extended along a direction of a drive shaft of the compression unit.

In addition, it is preferable that the inverter includes electric parts, and a tall electric part among the electric parts is arranged at an upper side in the housing when the electric compressor is installed on the vehicle.

According to this, capacity of the refrigerant liquid accumulation portion can be obtained sufficiently.

In addition, it is preferable that the inverter includes electric parts, and a heat-generating electric part among the electric parts is arranged at a lower portion in the housing when the electric compressor is installed on the vehicle, and heat radiating fins that radiate heat of the heat-generating electric part are protruded in the refrigerant liquid accumulation portion.

According to this, heat of the heat-generating electric parts can be radiated through the heat radiating fins, and thereby the inverter can be prevented from over-heating. Therefore, the inverter can be prevented from being damaged.

### BRIEF DESCRIPTION OF DRAWINGS

FIG. 1 It is an overall cross-sectional view of an electric compressor according to an embodiment.

FIG. 2 It is an overall cross-sectional view of an electric compressor according to another embodiment.

### DESCRIPTION OF EMBODIMENTS

Hereinafter, embodiments of an electric compressor will be described with reference to the drawings.

### First Embodiment

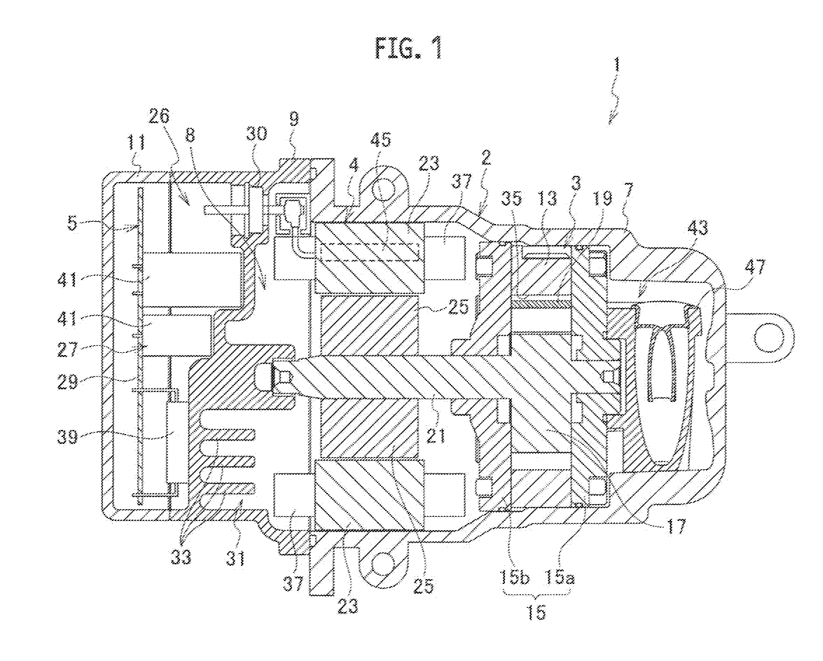

As shown in FIG. 1, an electric compressor 1 according to a first embodiment is installed on a vehicle, and integrated in a refrigeration cycle of an air-conditioner. The electric compressor 1 includes a hollow cylindrical housing 2, a compression unit that compresses refrigerant, a motor 4 that generates a drive power, and an inverter 5 that controls the motor 4.

The housing 2 includes a rear case 7 that houses the compression unit 3 and the motor 4, a front case 9 that is disposed so as to close an opening of the rear case 7, and an inverter case 11 that is attached to the front case 9 on an opposite side to the rear case 7.

The compression unit 3 is housed in the rear case 7 that has a bottomed hollow cylinder shape. The compression unit 3 includes a cylinder block 13 that has an ellipsoidal circumferential surface, side blocks 15 (15a and 15b) disposed both sides of the cylinder block 13, a rotor 17 that is rotatably housed in the cylinder block 13, vanes 19 that are inserted in vane slots formed on the rotor 17, and a drive shaft 21 that is formed monolithically with the rotor 17. The drive shaft 21 is rotated by the drive power of the motor 4.

Note that, when the compression unit 3 is pressed into the rear case 7, discharge chamber 43 in which the refrigerant is discharged to a bottom side of the rear case 7 is formed. A gas-liquid separator 47 that separates refrigerant gas and liquid (e.g. oil) included in the refrigerant from each other is disposed in the discharge chamber 43.

In addition, a compression chamber 35 is formed in the cylinder block 13 by sandwiching the cylinder block 13 by the rear side block 15a and the front side block 15b. Along with rotations of the rotor 17, end edges of the vanes 19 protruded from the vane slots on the rotor 17 are slidably contacted with the inner circumferential surface of the cylinder block 13 and thereby the refrigerant is compressed. The compressed refrigerant is discharged to the discharge chamber 43.

The motor 4 serve as a drive source of the rotor 17 includes a stator 23 disposed orderly along an inner circumference of the rear case 7, and a motor rotor 25 disposed within the stator 23. The drive shaft 21 of the compression unit 3 is press-fitted into the motor rotor 25.

The stator 23 is formed by winding coils 37 around teeth. Magnetic fields are generated by flowing electric currents through the coils 37, and thereby the motor rotor 25 is rotated by the magnetic fields.

In addition, wires are lead out from plural coils 37 one by one, and these wires are connected with a single neutral point 45. In a state where the electric compressor 1 is installed on a vehicle, the neutral point 45 is arranged at an upper portion in the housing 2. The neutral point 45 is connected with the inverter 5 via an after-described hermetic terminal 30.

The inverter 5 that controls the motor 4 is disposed in an inverter chamber 26 that is formed by sealing up a portion, on an opposite side to the rear case 7, of the front case 9.

The inverter 5 includes electric parts 27 and a circuit board 29. The electric parts 27 contains a switching element 39 that generates heat, and tall parts 41 (large electric parts 41 in size) that are taller than the switching element 39. The switching element 39 is an intelligent power management module, for example. The tall part(s) 41 is a common mode coil, a normal mode coil, a capacitor for an input to the inverter 5, a transformer, a capacitor for an internal power source, or the like.

In a state where the electric compressor 1 is installed on a vehicle, the switching element 39 that is short (in a direction of the drive shaft 21) among the electric parts 27 is arranged at a lower portion in the inverter chamber 26 (housing 2), and the tall parts 41 that are taller (in the direction of the drive shaft 21) than the switching element 39 are arranged on an upper side in the inverter chamber 26 (housing 2).

The front case 9 is disposed between the rear case 7 and the inverter case 11. The front case 9 is attached to the rear case 7 so as to close the opening of the rear case 7, so that a motor chamber 8 is formed. The motor chamber 8 houses the compression unit 3 and the motor 4. Lubricating oil is accumulated in the motor chamber 8. In addition, a suction port (not shown) through which the refrigerant is suctioned into the motor chamber 8 is provided on a circumferential wall of the motor chamber 8.

The hermetic terminal 30 that electrically connects the motor 4 and the inverter 5 with each other and a refrigerant liquid accumulation portion 31 that accumulates the refrigerant liquid are provided in the front case 9. In a state where the electric compressor 1 is installed on a vehicle, the hermetic terminal 30 is arranged at an upper portion in the front case 9, and the refrigerant liquid accumulation portion 31 is arranged at a position lower than the hermetic terminal 30. In the present embodiment, the refrigerant liquid accumulation portion 31 is arranged at a lower portion in the front case 9 in a state where the electric compressor 1 is installed on a vehicle.

Heat radiating fins 33 are protruded from a partition wall of the front case 9 in the refrigerant liquid accumulation portion 31. Note that the switching element 39 is arranged on an opposite side of the partition wall to the heat radiating fins 33. Heat generated by the switching, element 39 is conducted to the heat radiating fins 33 through the partition wall, and then radiated to the refrigerant liquid accumulated in the refrigerant liquid accumulation portion 31.

Next, operations of the electric compressor 1 will be described.

The motor 4 is controlled by the inverter 5. On this occasion, a control signal flows from inverter 5 to the hermetic terminal 30 and the neutral point 45 in this order, and then electric currents flow through the coils 37 of the stator 23 to generate magnetic fields. Due to the generation of the magnetic fields, the motor rotor 25 is rotated, and the rotor 17 of the compression unit 3 is rotated via the drive shaft 21.

The vanes 19 are protruded from the vane slots due to a centrifugal force accompanied by the rotations of the rotor 17, and their end edges are slidably contacted with the inner circumferential surface of the cylinder block 13 to compress the refrigerant. The compressed refrigerant is discharged to the discharge chamber 43 through a discharge hole (not shown). The refrigerant discharged to the discharge chamber is further discharged from a discharge port (not shown) to the refrigeration cycle through the gas-liquid separator 47.

If the electric compressor is stopped for a long time when outside temperature is low as in winter, the internal refrigerant may be liquidized. The liquidized refrigerant (refrigerant liquid) flows down due to gravitational attraction, and then is accumulated in the refrigerant liquid accumulation portion 31. Namely, the refrigerant liquid accumulation portion 31 is disposed at the lower portion of the electric compressor 1 in a state where the electric compressor 1 is installed on a vehicle, so that the refrigerant liquid can be accumulated in the refrigerant liquid accumulation portion 31.

In this manner, the refrigerant liquid can be accumulated in the refrigerant liquid accumulation portion 31 by providing the refrigerant liquid accumulation portion 31 at the lower portion in the housing 2, and thereby the neutral point 45 and the hermetic terminal 30 that are arranged at the upper portion can be prevented from being submerged in the refrigerant liquid. Therefore, the insulation property in the electric compressor 1 can be kept.

In addition, since the refrigerant liquid accumulation portion 31 is provided at a position lower than the hermetic terminal 30 and the neutral point 45, the hermetic terminal 30 and the neutral point 45 can be prevented from being submerged in the refrigerant liquid more surely. Therefore, the insulation property in the electric compressor 1 can be kept more surely.

Further, capacity of the refrigerant liquid accumulation portion 31 can be obtained sufficiently at the lower portion in the housing 2 by disposing the tall electric parts 27 (tall parts 41) at the upper potion in the housing 2 (the inverter chamber 26).

Further, heat of the heat-generating electric parts 27 (the switching element 39) can be radiated through the heat radiating fins 33 by disposing the heat-generating electric parts 27 (the switching element 39) at the lower position in the housing 2 (the inverter chamber 26 and protruding the heat radiating fins 33 to the refrigerant liquid accumulation portion 31. Therefore, the inverter 5 can be prevented from over-heating, and thereby the inverter 5 can be prevented from being damaged.

Further, the refrigerant liquid can be preventing from infiltrating into the compression unit 3 by accumulating the refrigerant in the electric compressor 1 at the refrigerant liquid accumulation portion 31. Therefore, compression efficiency of the electric compressor 1 never degraded, because it never occurs that the refrigerant liquid infiltrating into the compression unit 3 (that is not the suctioned refrigerant liquid) compressed at startup of the electric compressor 1.

Further, the lubricating oil in the electric compressor 1 can be also prevented from being made effluent through the compression unit 3 together with the refrigerant liquid by accumulating the refrigerant liquid in the electric compressor 1 at the refrigerant liquid accumulation portion 31.

Note that, in the present embodiment, the refrigerant liquid accumulation portion 31 is extended from the partition wall of the front case 9 toward the motor 4 along the direction of the drive shaft 21. However, the refrigerant liquid accumulation portion 31 may be provided along a circumferential direction of the circumferential wall of the motor chamber 8. Namely, it is sufficient that the refrigerant liquid accumulation portion 31 is provided at the lower portion in the front case 9 (the housing 2) as a space for accumulating the refrigerant liquid.

In addition, in the present embodiment, the refrigerant liquid accumulation portion 31 is provided between the inverter 5 and the motor 4. Here, the refrigerant liquid accumulation portion 31 may be provided by outwardly expanding the circumferential wall of the motor chamber 8 between the inverter 5 and the motor 4.

### Second Embodiment

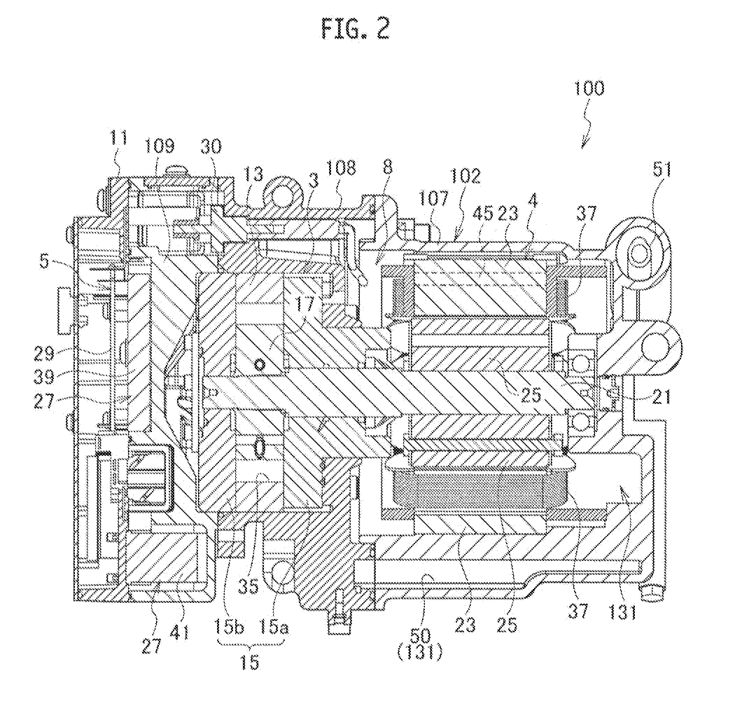

A electric compressor 100 according to a second embodiment will be described with reference to FIG. 2. Note that, in the present embodiment, equivalent or identical components to those in the above-described first embodiment are labeled with identical reference numerals, and thereby descriptions of them will be omitted.

As shown in FIG. 2, a housing 102 of the electric compressor 100 according to the second embodiment includes a front case 107 that houses the motor 4, a middle case 108 that houses the compression unit 3, a rear case 109 that closes an opening of the middle case 108, and the inverter case 11 that houses the inverter 5.

In a state where the electric compressor 100 is installed on a vehicle, an oil accumulation portion 50 that accumulates lubricating oil is formed at a lower port-ion of the front case 107. In addition, a refrigerant liquid accumulation portion 131 is formed so as to be protruded outward from a bottom face of the front case 107. In addition to the lubricating oil, the refrigerant liquid is also accumulated in the oil accumulation portion 50. Namely, the oil accumulation portion 50 functions also as the refrigerant liquid accumulation portion 131.

Refrigerant is suctioned from the suction port (not shown) provided on the middle case 108, and then compressed by the compression unit 3 disposed in the middle case 108. The compressed refrigerant is discharged into the front case 107 through the discharge hole (not shown). The refrigerant discharged into the front case 107 cools the motor 4, and then further discharged to the refrigeration cycle from the discharge port (not shown).

If the refrigerant in the housing 102 is liquidized due to a long-time stop of the electric compressor 100 or the like, the liquidized refrigerant (refrigerant liquid) flows down due to gravitational attraction, and then is accumulated in the refrigerant liquid accumulation portion 131 (the oil accumulation portion 50).

Therefore, similarly to the first embodiment, the above-described advantages can be brought by the electric compressor 100 according to the present embodiment.

In addition, since the oil accumulation portion 50 functions also as the refrigerant liquid accumulation portion 131, it is possible to accumulate more refrigerant liquid.

Although the present invention is described as above by referring the embodiments of the present invention, the present invention is not limited to the above-described embodiments. Scope of the present invention is determined in the context of the claims.

1. An electric compressor to be installed on a vehicle, the compressor comprising:
a hollow cylindrical housing;
a compression unit that is provided in the housing, and compresses refrigerant;
a motor that provided in the housing, and functions as a drive source of the compression unit;
an inverter that provided in the housing, and controls the motor; and
a refrigerant liquid accumulation unit that is provided in the housing, and accumulates refrigerant liquid in the housing, wherein
the refrigerant liquid accumulation unit is disposed at a lower portion in the housing when the electric compressor is installed on the vehicle.

2. The electric compressor according to claim 1, wherein,
the motor has a stator around which coils are wound and a motor rotor,
a neutral point of the coils is connected with the inverter via a hermetic terminal, and
the refrigerant liquid accumulation portion is arranged at a lower position than the hermetic terminal and the neutral point when the electric compressor is installed on the vehicle.

3. The electric compressor according to claim 1, wherein
the refrigerant liquid accumulation portion is extended along a direction of a drive shaft of the compression unit.

4. The electric compressor according to claim 1, wherein
the inverter includes electric parts, and
a tall electric part among the electric parts is arranged at an upper side in the housing when the electric compressor is installed on the vehicle.

5. The electric compressor according to claim 1, wherein
the inverter includes electric parts, and
a heat-generating electric part among the electric parts is arranged at a lower portion in the housing when the electric compressor is installed on the vehicle, and heat radiating fins that radiate heat of the heat-generating electric part are protruded in the refrigerant liquid accumulation portion.
